(19) United States
(12) Patent Application Publication
(10) Pub. No.: US 2006/0174533 A1
(43) Pub. Date: Aug. 10, 2006

(54) Animal repellent system

(75) Inventors: James J. Rusciano, Hopewell Junction, NY (US); Domenick V. Turchioe, Valhalla, NY (US)

Correspondence Address: MICHAUD-DUFFY GROUP LLP, 306 INDUSTRIAL PARK ROAD, SUITE 206, MIDDLETOWN, CT, 06457, US

(73) Assignee: Nature Technologies, Inc., Pleasantville, NY (US)

(21) Appl. No.: 11/244,839

(22) Filed: Oct. 6, 2005

Related U.S. Application Data
(60) Provisional application No. 60/616,568, filed on Oct. 6, 2004.

(51) Int. Cl. A01M 31/00

(52) U.S. Cl. 43/1

(57) ABSTRACT

An animal repellant system which includes triggering means for detecting the presence of animals within a particular area and generating signals indicative thereof. The animal repellant system includes a controller operable to receive the signals generated by the triggering means and to issue command signals responsive thereto, and deterrent means for effectuating a repellant component of the animal repellant system in response to the command signals issued by the controller, thereby dissuading the animals from entering the particular area.

This application claims priority from provisional application Ser. No. 60/616,568, filed Oct. 6, 2004, the disclosure of which is incorporated by reference in its entirety.

### FIELD OF THE INVENTION

The present invention is generally directed to animal repellant systems and is more specifically directed to a controller based system that is capable of exploiting several different techniques to deter certain animals from entering particular areas.

### BACKGROUND OF THE INVENTION

By nature animals roam from one location to another seeking food, water, and shelter. As a result it is inevitable that at times they encroach upon people's property. In some instances an animal's presence can be beneficial, yet there are other situations in which an animal's presence is destructive, burdensome, dangerous, annoying or otherwise undesirable. Skunks, bear, deer, birds, woodchucks, rabbits, dogs, cats, cows, horses, and many other animals may from time to time roam onto and undesirably intrude upon one's property.

History provides an example of such undesirable animal intrusions in the case of deer. Nationally, whitetail deer population estimates range from 20 million to 33 million, which represents a larger deer population than that which existed when Christopher Columbus arrived five centuries ago, according to a report in The Wall Street Journal, Dec. 1, 2004. Deer can be destructive and the damage they inflict on property is getting worse every year as their population grows. By nature, deer live on the edge of the forest where they can graze on plants, flowers and small trees while using the woods for cover. This makes residential backyards and commercial nurseries particularly inviting to deer. In fact, deer can eat as much as 3,000 pounds of plant matter a year or approximately 2,000,000 leaves. It is estimated that they cause more than $1 billion in residential property damage annually. Such grazing by deer can cause landscape damage, thus reducing the attractiveness of the property to potential buyers.

Many types of devices and methods have been and are presently being used to discourage animals, such as deer, from causing damage to landscaping material, such as perimeter fencing, which may or may not be electrified, as well as the covering of shrubs with some type of netting. These arrangements are time consuming and impair the aesthetics of the property to be protected. A keen sense of hearing and ability of animals, such as deer, to triangulate the exact origin of sounds is the animal's main defense against predators and danger in general. However, audio frequency emission systems for repelling deer presently in use are difficult to install and generally operate continuously thereby allowing deer to become accustomed to the constant audio output and thereby making the devices ineffective.

There is a need to provide a method or system for repelling animals that is convenient, is highly efficient and does not pose a physical risk to wildlife, pets and human beings. Prior art methods and systems for addressing these needs were either too expensive, inhumane, ineffective or a combination of all of these. Based on the foregoing, it is the general object of the present invention to improve upon or overcome the problem and drawbacks of the prior art.

### SUMMARY OF THE INVENTION

According to one aspect of the present invention, an animal repellant system is provided which includes a triggering means for detecting the presence of animals in a particular area and generating signals indicative thereof. The animal repellant system can include a controller in communication with the triggering means to receive the signals generated therefrom and to issue command signals responsive thereto. The animal repellant system also includes deterrent means for effectuating a repellant component of the animal repellant system in response to the command signals, thereby dissuading animals from entering into the particular area.

Another aspect of the current invention relates to an animal repellant system wherein the triggering means includes but is not limited to motion detectors, interrupted beam photo sensors, photo cells including photo cells with day and night program changes, pressure switches, and input from bi-directional data links. The triggering means can generate command signals or be connected to a controller which may be programmed to vary command signals according to non-periodic time and frequency patterns. In the preferred embodiment of the present invention, the controller produces the command signals.

In the preferred embodiment of the present invention the deterrent means includes a power amplifier and audio driver that generates sound in response to commands issued from the controller. The sound generated by the controller can be in the ultrasonic range, the sonic range or a combination thereof. Piezo electric audio drivers are preferred for effectuating sound wave type repellant components. When using piezo-electric audio drivers it is preferable that the wave signals be square waves which contain a fundamental frequency plus harmonic frequencies. Certain audio drivers which are constructed to increase the distortion of the audio output beyond that which is inherent in the square wave that is fed to the audio driver, can also be used in the present invention. Although piezo-electric audio drivers are preferred, the present invention is not limited in this regard as Terfenol (ETREMA TERFENOL-D is registered trademark of Edge Technologies, Inc., Registration No. 1512330) dynamic, ribbon, electrostatic, and plasma audio drivers may also be used. While audio drivers have been described, the present invention is not limited in this regard as other deterrent means such as strobe lights, sprinklers, alarm systems and spot lights can also form a repellant component of the present invention.

When audio drivers are used, pattern variations in audio output can be governed by the controller through generation and transmission of command signals and wave signals. The command signals can include wave signals such as but not limited to square waves, saw-tooth waves and sine waves The controller can cause a number of changes in the output of one or more repellant components using a preprogrammed protocol. Fore example, frequency, duration, number and direction of audio drivers actuated, selection of different frequency patterns, cancellation of ambient noise, total time interval in which command signals are generated, cadence type output defining the order or pattern in which sound is made, range and decibel level of the command signals and time interval where no frequency output occurs, can be changed. The preprogrammed protocol can also vary changes in the command signals over a random series of steps. In addition, the preselected time interval can be varied depending upon the signals generated from the triggering means.

A further aspect of the current invention relates to an arrangement of animal repellant systems comprising at least two animal repellant systems that are connected by a bidirectional communication network linking the controller in each of the animal repellant systems to at least one other animal repellant system. The arrangement can include at least two animal repellant systems controlled by a central controller or by a controller contained in each animal repellant system which works cooperatively with other controllers in a bidirectional communication network. The bi-directional communication network can be in the form of dedicated communication wiring, power wires used for communication and wireless radio frequency transceivers for communication purposes. In one embodiment of the present invention, wherein the power wires are used for bi-directional communication, measures well known to those skilled in the relevant art of communication over power wires are implemented to reduce noise levels and attenuation at operating frequencies. The animal repellant system can also communicate using standard protocols such as phone, cable or the internet.

### DESCRIPTION OF THE DRAWINGS

FIG. 1 is a perspective view of an animal repellant system in accordance with the teachings of the present invention.

FIG. 2 is a perspective view of a bottom portion of the animal repellent system illustrated in FIG. 1 showing detail regarding the bottom of the controller.

FIG. 3 is a schematic view of the animal repellant system of the present invention.

FIG. 4 is a schematic view of a projection cone for providing square wave distortion in practicing the present invention.

FIG. 5 is a diagrammatic view showing a repellant system operatively connected to a microphone to detect and cancel ambient noise.

FIG. 6 is a block diagram showing a plurality of animal repellant systems connected in a serial pattern with individual controllers housed within each animal repellant system.

FIG. 7 is a block diagram similar to that shown in FIG. 6 but showing a network of animal repellant systems controlled by a central controller.

FIG. 8 is a top view of an arrangement of animal repellent systems, of the present invention, situated on a parcel of land, and further illustrating overlapping ranges of the repellent systems.

FIG. 9a is a schematic diagram illustrating communication links between the controller and the motion detectors of the animal repellant system, using separate wires for bi-directional communication and power transmission.

FIG. 9b is a schematic diagram illustrating communication links between the controller, and the motion detectors of the animal repellant system, using the power wires for both bi-directional communication and power transmission.

FIG. 9c is a schematic diagram illustrating communication links between the controller, and the motion detectors of the animal repellant system, using separate wires for power transmission and a wireless link for bi-directional communication.

### DETAILED DESCRIPTION OF THE PREFERRED EMBODIMENT

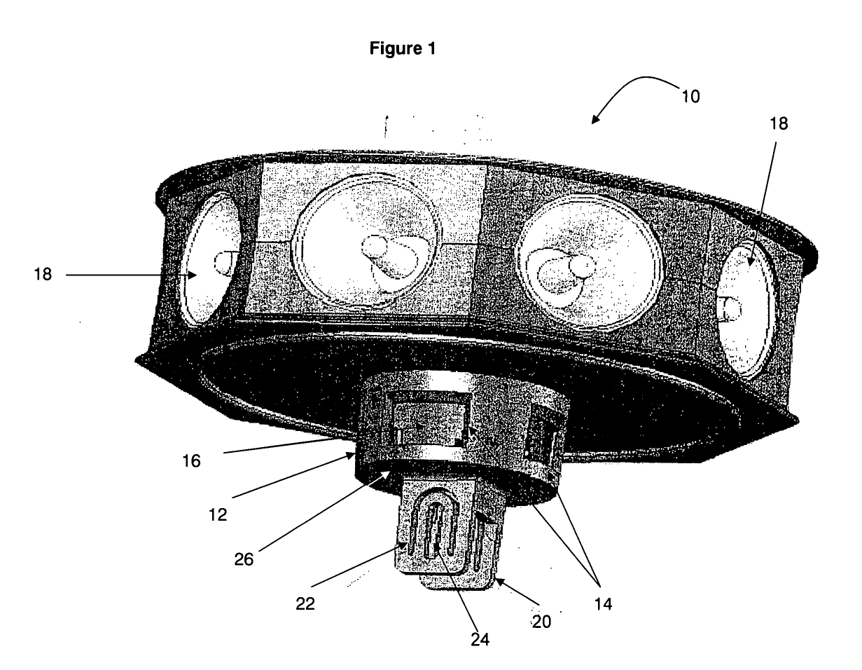

FIG. 1 illustrates an animal repellant system 10, including a control module 12 housing a controller positioned therein. The control module 12 includes four ports 14 each housing a motion detector 16 for detecting a presence of animals in a particular area and for generating signals indicative thereof. The four motion detectors 16 are positioned in an array defining an approximately common plane. Each motion detector 16 is substantially evenly spaced around a first perimeter of the animal repellent system 10 and positioned about 90 degrees from another motion detector. FIG. 1 further shows an animal repellant 10 system including eight audio drivers 18 arrayed uniformly around a second perimeter of the animal repellant system 10 for multidirectional broadcasting a repellant component consisting of sound waves. While sound waves have been described above, the present invention is not limited in this regard as sprinklers, spotlights, scent dispensers, and strobe lights can also be used. Although the motion detectors 16 are shown on the approximately common plane, the invention is not limited in this regard, as the motion detectors 16 can be positioned on more than one plane and different planes. While four motion detectors 16 are shown evenly spaced and positioned about 90 degrees apart, the present invention is not limited in this regard as at least one motion detector can be used and motion detectors can be non-evenly spaced around the animal repellant system 10.

Again referring to FIG. 1, an attachment clip 20 projects outwardly from a bottom 26 of the control module 12. The attachment clip includes rotational hinging grooves 22 and an attachment slot 24 which are adapted to rotatably mate complementarily with a support post and bracket (not shown) which has corresponding mated hinge guides that allow the animal repellant system 10 to be rotated at least 90 degrees in either direction. While the attachment clip 20 has been shown, the invention is not limited in this regard as other mechanisms for rotatably mounting the animal repellant 10 system to the support post can be employed.

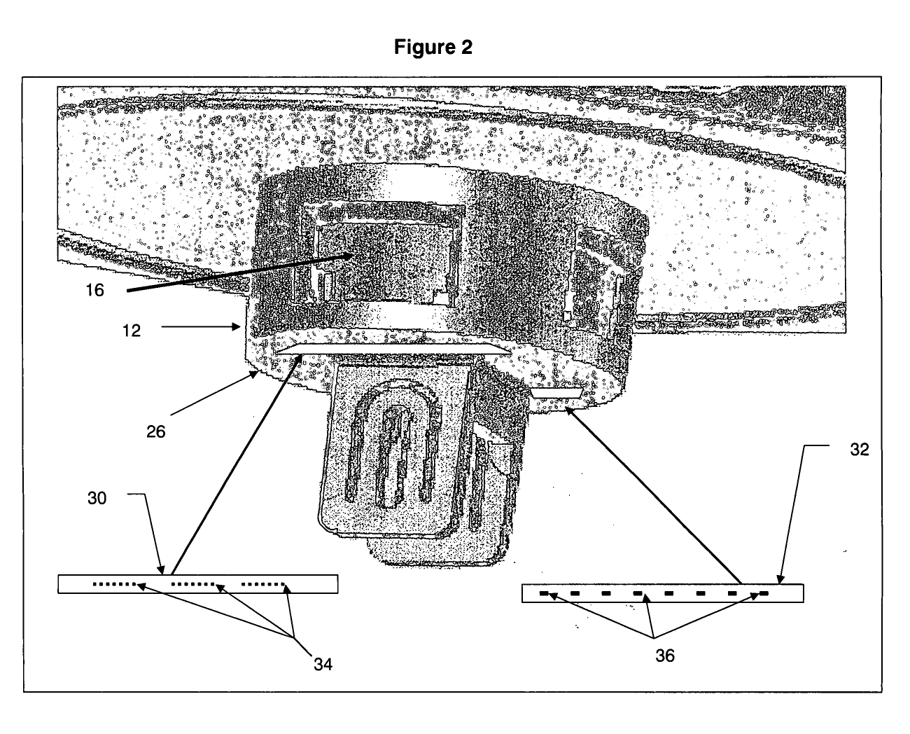

FIG. 2 illustrates a first data port 30 and a second port 32 positioned on the bottom 26 of the control module 12. The first data port 30 and the second port 32 are protected by flexible boots (not shown) positioned therein. The first data port 30 houses connections 34 for phone lines, the internet, and USB lines, for field maintenance and reprogramming of the controller. The second port 32 houses dip switches 36 for controlling operational modes of the animal repellant system 10. Although the flexible boots are shown for protection of the first data port 30 and second port 32, the invention is not limited in this regard as a cover positioned over the first data port and the second port, such that a tool would be required to remove the cover, can also be used. While the data port 30 and the second port 32 are shown, the present invention is not limited in this regard as radio frequency, internet, and other communication devices can be used.

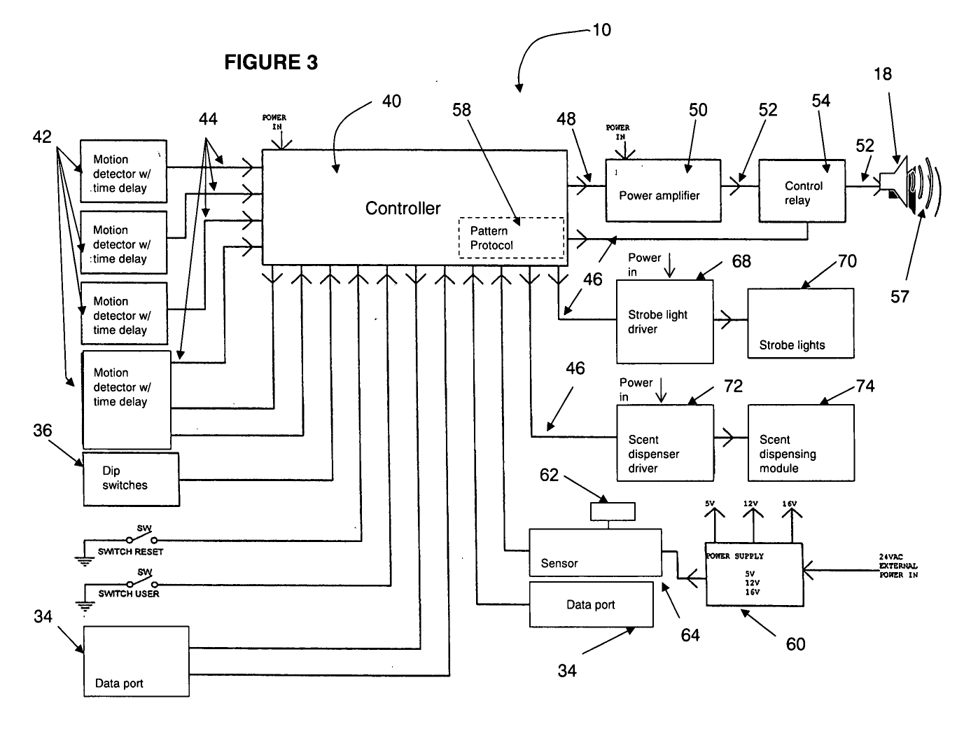

FIG. 3 shows the animal repellent system 10, including the controller 40 and four motion detectors 42 for detecting the presence of an animal or other moving heat source, in the particular area. The motion detectors 42 include a built-in time delay circuit which delays transmission of a motion signal 44 until a predetermined time elapses. Motion signals 44 are continuously or intermittently relayed to the controller 40. Although the above mentioned embodiment of the present invention discloses the motion detector 42, the current invention is not limited in this regard as interrupted beam photo sensors, photo cells including photo cells with day and night program changes, pressure switches, and input from bi-directional data links, can also be used. While the motion detector 42 is shown with the time delay, the controller 40 can also be used to provide the time delay function.

FIG. 3 also shows the audio driver 18 connected to a control relay 54 and a power amplifier 50 for output of sound waves. The controller 40 generates wave signals 48 and command signals 46. The controller 40 includes a protocol 58 for varying the command signals 46 according to a pattern. The wave signals 48 are transmitted to a power amplifier 50 for generation of amplified wave signals 52 of high wattage output and transmission of the amplified wave signals 52 to the control relay 54. The control relay 54 receives the amplified wave signals 52 and transmits the amplified wave signals 52 to the audio driver 18 for broadcasting a repellant component consisting of a pattern of varied frequency ultrasonic sound waves 57. Although the animal repellant system 10 described above is operative primarily in the ultrasonic frequency range, the animal repellant system can also operate in the sonic range or in a combination of sonic and ultrasonic ranges.

FIG. 3 also shows strobe lights 70 built into the animal repellant system 10 and connected to a strobe light driver 68. A scent dispensing module 74 connected to a scent dispenser driver 72, is also schematically illustrated. The command signals 46 are transmitted to the strobe light driver 68 for activation of the strobe lights 70 thereby effectuating the repellant component consisting of high intensity light flashes. Command signals 46 are also transmitted to the scent dispenser driver 72 for activation of the scent dispensing module 74 thereby effectuating the repellant component consisting of at least one scent. While strobe lights 70 and scent dispensing modules 74 are shown, the current invention is not limited in this regard, as other repellant components including but not limited to a sprinkler system for effectuating a repellant component consisting of water, an audible range sound delivery system, such as an alarm system, for effectuating a repellant component consisting of audible sound and spot lights for effectuating a repellant component consisting of light, can also be used. While the strobe lights 70 are shown built into the animal repellant system 10, the present invention is not limited in this regard as the strobe lights can be separate from the animal repellant system.

FIG. 3 also illustrates a sensor 64 for determining whether power supply is available to the animal repellant system 10 and annunciating a status of the power supply. The sensor 64 is shown with back-up battery power 62. The animal repellant system 10 is shown connected to a 24 volt alternating current power supply 60. The connections 34 for phone lines, the internet, and USB lines, for field maintenance and reprogramming of the controller 40, are also shown. The animal repellant system 10 also includes the dip switches 36 for controlling operational modes of the animal repellant system 10. Although the sensor 64 is shown for determining whether power is available to the animal repellant system 10, the present invention is not limited in this regard as other sensors can also be used to determine and annunciate other parameters of the animal repellant system. While the 24 volt alternating current power supply 60 is shown, the present invention is not limited in this regard as other power supplies can also be used, including but not limited to, solar and battery power.

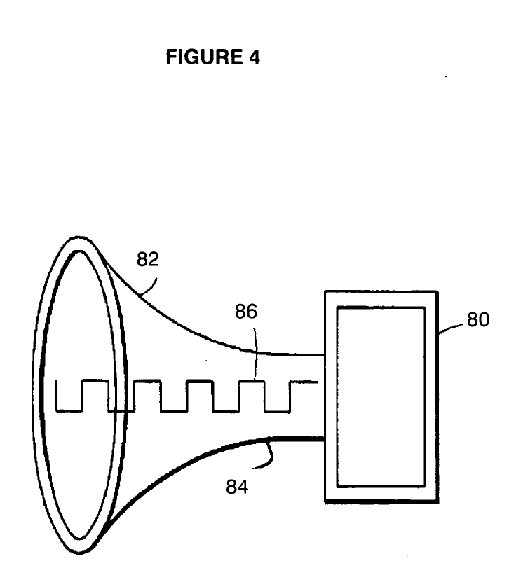

FIG. 4 illustrates a piezo electric audio driver 80 emitting square wave signals 86 characterized by at least one frequency and wave length for use with the animal repellant system 10. The piezo electric audio driver 80 includes a projection cone 82 which broadcasts the square wave signals 86. The projection cone 82 has a throat 84 section which produces inter-modulation and harmonic distortion, caused by a non-linear compression of air in the throat 84 of the projection cone 82. While the square wave 86 is shown, other wave forms such as saw-tooth and sine waves can also be used. Although the piezo electric audio drivers 80 have been described, the present invention is not limited in this regard, in that other audio drivers can be used including but not limited to, Terfenol (ETREMA TERFENOL-D is registered trademark of Edge Technologies, Inc., Registration No. 1512330) dynamic, ribbon, electrostatic, and plasma audio drivers or a combination thereof.

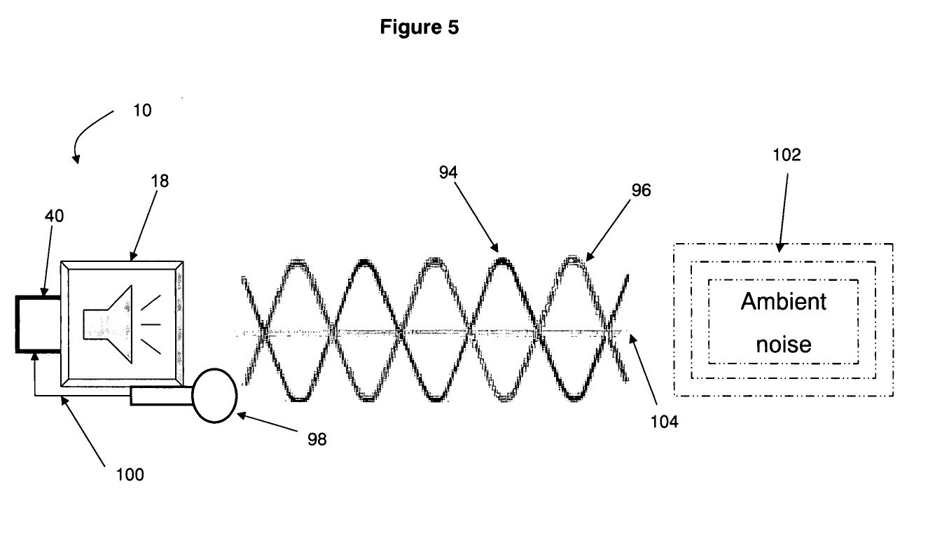

FIG. 5 illustrates a microphone 98 coupled to the audio driver 18. The microphone 98 detects ambient noise 102 and converts the ambient noise into noise wave signals 94. The microphone 98 transmits the noise wave signals 94 through the communication link 100 to the controller 40. The noise wave signals 94 are analyzed by the controller 40, wherein the controller generates canceling wave signals 96 which are exactly opposite to and 180 degrees out of phase with the noise wave signals 94. The audio driver 18 emits the canceling wave signals 96 to create a null-zone 104 wherein no ambient noise is present. While the microphone 98 is shown coupled to the audio driver 18, the present invention is not limited in this regard as the microphone may be positioned remotely.

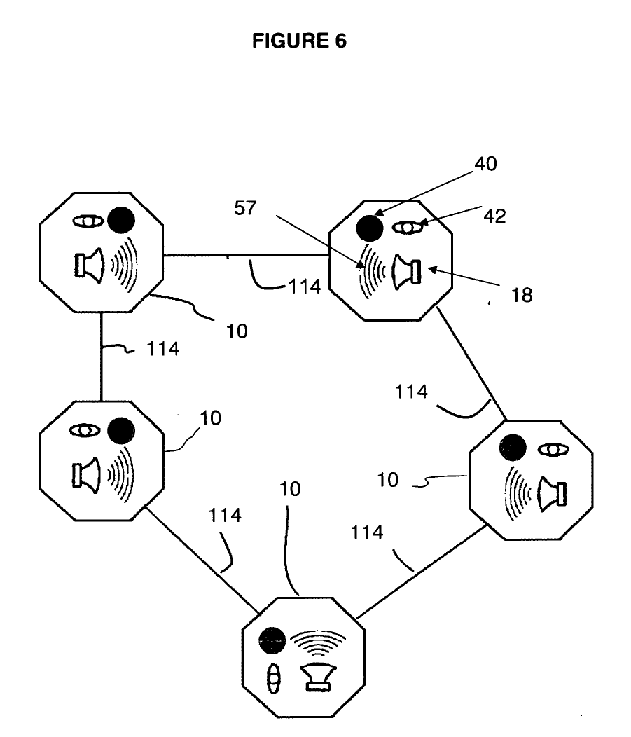

FIG. 6 shows at least two animal repellant systems 10 connected in series by links 114 such that the animal repellant systems activate simultaneously upon receipt of the motion signal 44. Each link 114 is illustrative of both a bi-directional communication link and a power wire. While simultaneous activation has been described, the present invention is not limited in this regard as independent activation of the animal repellant systems 10 is also possible.

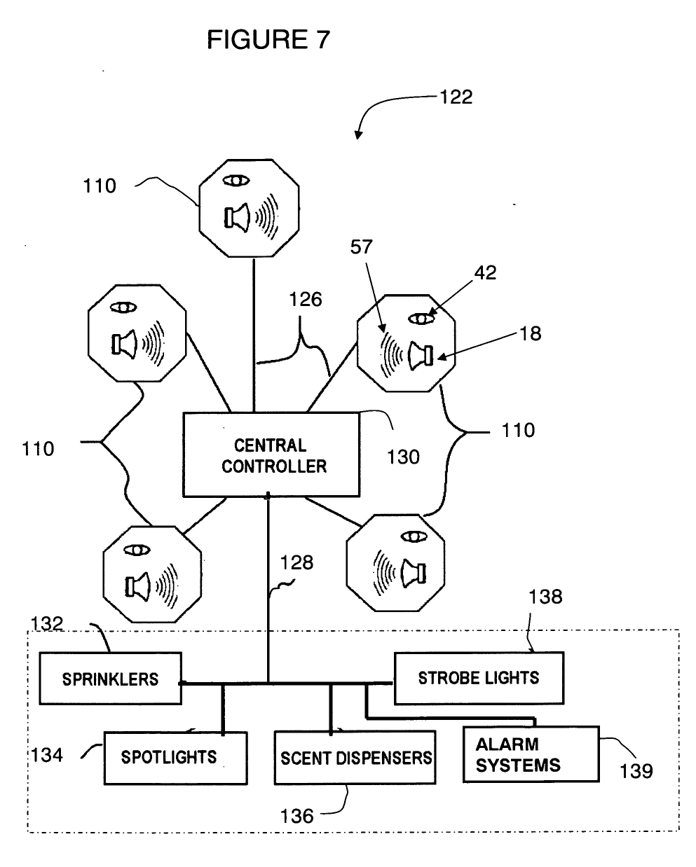

FIG. 7 illustrates a network 122 of animal repellant systems 110 controlled by a central controller 130 connected by links 126 to each animal repellant system in the network. The central controller 130 activates each animal repellant system 110 simultaneously. The central controller 130 also simultaneously activates sprinklers 132, spotlights 134, scent dispensers 136, strobe lights 138, and an alarm system 139 through links 128. Although the central controller 130 is shown to activate the animal repellant systems 110, sprinklers 132, spotlights 134, scent dispensers 136, strobe lights 138, and alarm system 139 simultaneously, the present invention is not limited in this regard, in that the controller 130 can provide other activation sequences. In other embodiments of the present invention, a control module of a home security system can be interfaced with the central controller 130.

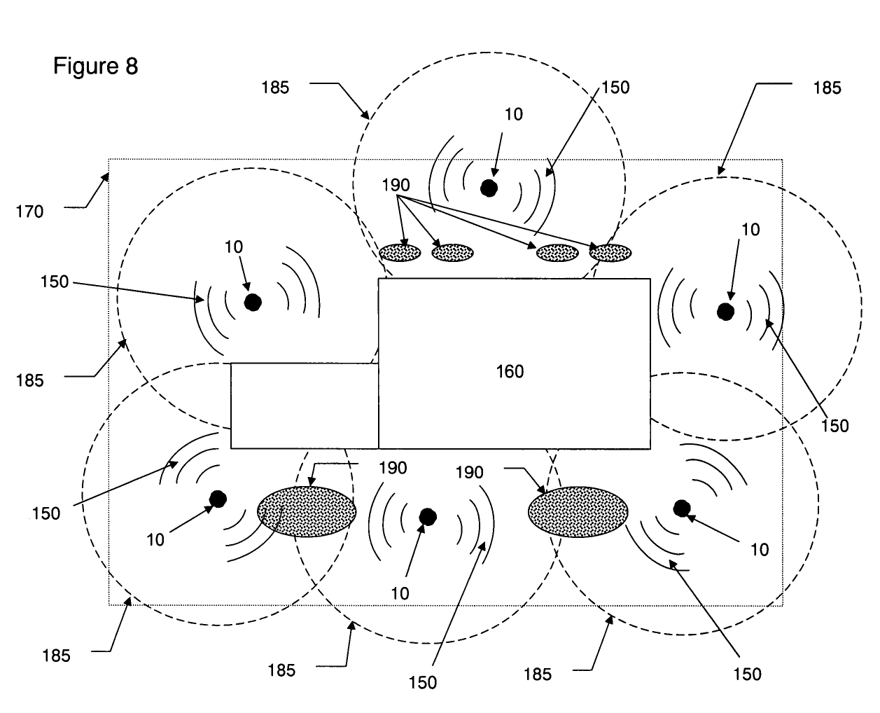

Referring to FIG. 8, six animal repellent systems 10 are positioned around a residential structure 160, affixed to a parcel of land 170. The animal repellant systems 10 have an effectiveness range 185 of up to 360 degrees. The animal repellant systems 10 are shown positioned such that the effectiveness ranges 185 overlap. The effectiveness ranges 185 are further defined by a radius extending outwardly from the animal repellant systems 10 by a distance, at which the repellant component diminishes by less than half. The animal repellant system 10 illustrates uses of ultrasonic waves 150 as the repellant component wherein the ultrasonic waves deflect off the structure 160 and shrubs 190. Deflection of ultrasonic waves 150, broadcast at a frequency from the animal repellant system 10, causes interference patterns which change when the frequency of the ultrasonic wave changes. While animal repellant systems 10 are shown positioned around the residential structure 160, the present invention is not limited in this regard as the animal repellant systems can be positioned on and around residential structures and other structures and locations.

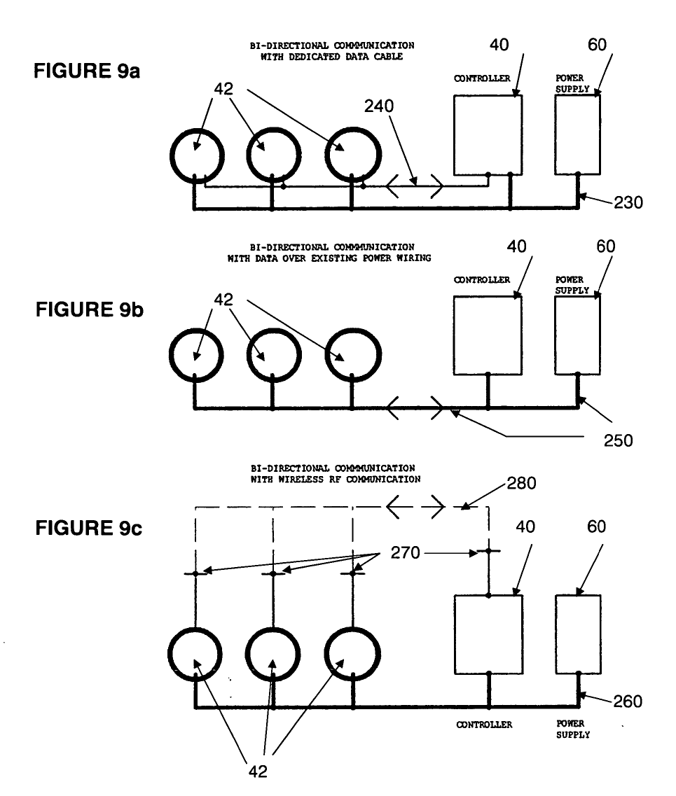

FIG. 9a shows the power supply 60 providing power through a power wire 230 to the controller 40 and three motion detectors 42. A separate communication wire 240 connects the controller 40 with the motion detectors 42, providing bi-directional communication therebetween. The bi-directional communication wire 240 is shown arranged in tandem with the power wires 230. FIG. 9b illustrates use of power wires 250 for transmission of power from the power supply 60 to the controller 40 and three motion detectors 42. In FIG. 9b, the power wires 250 are also used for bi-directional communication between the controller 40 and three motion detectors 42. FIG. 9c illustrates use of a wireless system including transceivers 270 for generation of a wireless radio frequency link 280 for bi-directional communication between the controller 40 and the three motion detectors 42. FIG. 9c illustrates use of a separate power wire 260 for transmission of power to the controller 40 and three motion detectors 42. While FIGS. 9a, 9b and 9c illustrate bi-directional communication between the controller 40 and the motion detectors 42, the present invention is not limited in this regard as bi-directional communication using the separate wire, the power wire and the wireless system can also be used for bi-directional communication between other components of the animal repellant system 10 including but not limited to the power amplifier 60, the audio driver 18, the scent dispersing drivers 68 and the strobe light drivers 68.

Although the present invention has been disclosed and described with reference to certain embodiments thereof, it should be noted that other variations and modifications may be made, and it is intended that the following claims cover the variations and modifications within the true spirit of the invention.

What is claimed is:

1. An animal repellant system comprising:
triggering means for detecting a presence of animals within a particular area and for generating signals indicative thereof;
a controller operable to receive said signals generated by said triggering means and to issue command signals responsive thereto; and
deterrent means for effectuating a repellant component of said animal repellent system in response to said command signals issued by said controller, thereby dissuading said animals from entering said particular area.

2. An animal repellant system as defined in claim 1 wherein said triggering means includes at least one motion detector.

3. An animal repellant system as defined in claim 1 wherein said at animal repellant system is operable to cover up to 360 degrees around said animal repellant system.

4. An animal repellant system as defined in claim 1 wherein said command signals include wave signals.

5. An animal repellant system as defined in claim 4 wherein said wave signals are square wave signals.

6. An animal repellant system as defined in claim 4 wherein said deterrent means includes:
a power amplifier operable to receive said wave signals and to create amplified wave signals; and
an audio driver for processing said amplified wave signals, for transforming said amplified wave signals into said repellant component and for broadcasting said repellant component.

7. An animal repellant system as defined in claim 6, including:
a microphone operable to detect ambient noise and to transmit noise wave signals corresponding thereto to said controller; wherein said audio driver, in response to said command signals, outputs sound waves exactly opposite to and 180 degrees out of phase with said ambient noise.

8. An animal repellant system as defined in claim 6 further comprising at least two audio drivers pointed in different directions.

9. An animal repellant system as defined in claim 6 wherein said audio driver is a piezo-electric audio driver.

10. An animal repellant system as defined in claim 1 wherein said deterrent means includes at least one strobe light.

11. An animal repellant system as defined in claim 1 wherein said deterrent means includes at least one scent dispensing module.

12. An animal repellant system as defined in claim 1 further comprising:
a first data port for accessing said controller; and
a second port for accessing said controller.

13. An animal repellant system as defined in claim 1 further comprising: an attachment clip projecting outwardly from a lower surface of said animal repellant system, said attachment clip being rotatably mounted to a support providing access to said lower surface.

14. A method for repelling animals from a particular area comprising the steps of:
providing at least one animal repellant system including triggering means for detecting a presence of animals within said particular area and for generating signals indicative thereof, a controller operable to receive said signals generated by said triggering means and to issue command signals responsive thereto, and deterrent means for effectuating a repellant component of said animal repellent system in response to said command signals issued by said controller, thereby dissuading said animals from entering said particular area
positioning said animal repellant system to detect said presence of animals within said particular area;
generating said signals via said triggering means upon detection of said animals indicative of said presence of animals within said particular area;
issuing said command signals via said controller responsive to said signals received from said triggering means; and
effectuating said repellant component of said animal repellant system in response to said command signals, thereby dissuading said animals from entering said particular area.

15. A method for repelling animals as defined in claim 14 including the step of:
positioning said at least one animal repellant system apart from another animal repellant system by a distance such that said repellant component diminishes by less than half at said distance.

16. A method for repelling animals as defined in claim 14 including the steps of:
setting via said controller, said repellant component to be sound waves characterized by a frequency; and
varying a rate of change of said frequency of said sound waves from about 1 frequency change per second to about 15 frequency changes per second.

17. A method for repelling animals as defined in claim 16 including the step of:
setting a time interval during which said frequency is zero.

18. A method for repelling animals as defined in claim 14 including the step of:
varying said command signals over a random series of steps from about 5 random steps to about 10 random steps over a preselected time interval.

19. A method for repelling animals as defined in claim 18 including the step of:
varying said preselected time interval depending upon said signals indicative of said presence of animals within said particular area.

20. A method for repelling animals as defined in claim 14 including the step of:
varying said command signals randomly.

21. A method for repelling animals as defined in claim 14 including the steps of:
sensing an operating status of said animal repellant system; and
annunciating said operating status of said animal repellant system.

22. A method for repelling animals as defined in claim 14 including the steps of:
providing at least two animal repellant systems, linking said at least two animal repellant systems in a network; and
providing a central controller to activate said at least two animal repellant systems.

23. A method for repelling animals as defined in claim 22 including the step of:
activating said at least two animal repellant systems simultaneously.

24. A method for repelling animals as defined in claim 22 including the step of:
activating said at least two animal repellant systems at various times.

25. A method for repelling animals as defined in claim 14 including the steps of:
providing a microphone;
coupling said microphone to said controller;
positioning said microphone for detecting ambient noise;
detecting said ambient noise;
converting said ambient noise to noise wave signals;
transmitting said noise wave signals to said controller for generation of canceling wave signals;
generating canceling wave signals exactly opposite to and 180 degrees out of phase with said noise wave signals;
transmitting said canceling wave signals to an audio driver for broadcasting said canceling wave signals; and
broadcasting said canceling wave signals to create a null zone wherein no ambient noise is present.
